(19) United States
(12) Patent Application Publication
(10) Pub. No.: US 2026/0185527 A1
(43) Pub. Date: Jul. 2, 2026

(54) SUBMERSIBLE CRYOGENIC LIQUID HYDROGEN PUMP ASSEMBLY

(71) Applicant: FENNESSY ENGINEERING, NEWPORT BEACH, CA (US)

(72) Inventor: CRAIG JAMES FENNESSY, HUNTINGTON BEACH, CA (US)

(21) Appl. No.: 19/130,650

(22) PCT Filed: Aug. 17, 2024
(86) PCT No.: PCT/US2024/042830

§ 371 Date: May 16, 2025

Related U.S. Application Data
(60) Provisional application No. 63/533,735, filed on Aug. 21, 2023.

(51) Int. Cl. F04D 13/08; F04D 7/02; F04D 29/42; F04D 29/70

(52) U.S. Cl. CPC F04D 13/08; F04D 7/02; F04D 29/426; F04D 29/708

(57) ABSTRACT

A cryogenic pump assembly comprising a centrifugal pump and an electric induction motor especially configured for transporting liquid hydrogen (LH₂) from cryogenic LH₂ storage tanks to various applications having a horizontal configuration that includes an offset discharge to prevent vapor lock. An integrated vacuum jacketed housing enclosing portions of the centrifugal pump and electric induction motor may be utilized to prevent heat loss, while another embodiment utilizes LH₂ flowing through the electric induction motor to lubricate bearings as well as cooling the electric induction motor. The centrifugal pump may be either single-stage or multi-stage, wherein each stage unit comprises an impeller and diffuser connected to a diffuser housing. The pump and motor share a single motor/pump shaft. Another embodiment is the cryogenic pump assembly vertically submerged in a cryogenic LH₂ storage tank or vertically submerged in a sump container attached either externally or internally to a cryogenic LH₂ storage tank.

### CROSS-REFERENCE TO RELATED APPLICATIONS

This utility patent application claims priority of U.S. Provisional Patent Application Ser. No. 63/533,735, filed on Aug. 21, 2023, entitled “Hydrogen Submerged Motor Pump” by inventor Craig James Fennessy, which application is incorporated herein in its entirety in this application by this reference.

### BACKGROUND OF THE INVENTION

### 1. Field of the Invention

The invention is related to a specifically-designed cryogenic pump assembly for liquid hydrogen (LH₂), and more generally, to a cryogenic liquid hydrogen pump assembly that can also be easily modified or defeatured to be used on liquid nitrogen (LN₂), liquid natural gas (LNG), and other cryogenic pumping systems as well. If the cryogenic pump assembly is used for LNG, the specifically-designed cryogenic pumping assembly can also be configured to be submersed in an LNG storage tank. Likewise, said specifically-designed cryogenic pump assembly for LH₂ can also be configured to be submersed vertically in a cryogenic LH₂ storage tank. The invention also discloses a cryogenic pump assembly for LH₂ configured without vacuum jacketing that does not need to be submerged in the cryogenic LH₂ tank but rather uses the process liquid flowing through the pumping assembly to lubricate the bearings and cool the electric induction motor.

### 2. Related Art

When pumping cryogenic liquids, there are generally two types of pumps that are used: centrifugal pumps and reciprocating pumps. Centrifugal pumps rely on a rotating disc to move the process fluid through the system, and increasing the diameter of the impeller or the rotational speed will lead to increased head or increased flow rate. Centrifugal pumps are used for higher flows and lower head applications. Accordingly, in most LH₂ applications, centrifugal pumps are preferred. Reciprocating pumps utilize a crankshaft-connecting rod mechanism similar to internal combustion engines and are used for higher pressure applications but have much lower flow rates. The efficiency of centrifugal pumps is also much lower than reciprocating pumps; the overall efficiency of a centrifugal pump normally ranges from 30 percent to 60 percent, while the overall efficiency of a reciprocal pump is generally 85 percent throughout its full operating range. It is of interest that many reciprocating pumps need boost pumps to help prevent cavitation, which boost pumps are centrifugal pumps.

Within the class of centrifugal pumps, there are various pump designs that use different sealing techniques to isolate the process fluid from the atmosphere. Generally, cryogenic centrifugal pumps used in the industrial gases industry are used to transfer liquid from one tank to another. Such pumps can be stationary or vehicle mounted, and the pumps can be used in processes that run continuously or intermittently. The sealing of cryogenic centrifugal pumps is challenging and also a maintenance issue. Cryogenic mechanical seals are a standard for the industrial market due to their availability, design simplicity, and cost advantages. Such mechanical seals can be costly and require continued maintenance. Mechanical seals are very sensitive to how the pump is started. Poor cool down and startup procedures significantly shorten seal life.

When a mechanical seal leaks, the process fluid is released into the atmosphere. In the industrial gases industry, it is generally considered not a problem if small quantities of the process fluid vaporize and leak into the atmosphere because the gases are typically relatively safe, such as nitrogen, argon, and oxygen.

Submerged motor pumps solve many of the above-discussed mechanical seal leak problems because there is not a need for a container between stationary and rotating parts. As the name suggests, the motor is submerged in the process liquid. The motor rotor is coupled with the pump shaft and the motor stator is also submerged in the process liquid. This type of design was popularized by the J. C. Carter Pump Company many years ago (see, for example, U.S. Pat. No. 3,369,715 issued Feb. 20, 1968 to James C. Carter, entitled “Submerged Pumping System”). In general, this patent discloses an LNG pumping and storage system comprising a pump and motor submerged at the bottom of a reservoir containing LNG that discharges the LNG from the bottom of the reservoir to the top the reservoir, a system which is basically in use today. That is, submerged motor pumps are very popular for use in propane, ethane, and LNG applications. Although industrial gases are inherently safe because they are inert liquids, other applications, such as propane, ethane, and LNG may not be. As will be appreciated, the reason combustible liquid applications are acceptable is because with the motors and pumps submerged in the liquid, there is no oxygen available to support any kind of combustion or fire. It is important to remember that these are all cryogenic applications.

Cryogenic pumps have some unique design considerations because of the extremely cold temperatures, and each type of process fluid generally requires slight design modifications for each application. There is currently a significant effort toward developing LH₂ as a green energy supply source. More specifically, sustainable green energy refers to LH₂ as a renewable non-fossil fuel used as an energy source that is abundant; it does not occur on earth in pure form but can be produced by pumping electricity through water (H₂O) in an electrolysis process. The liquefied LH₂ can then be stored in insulated cryogenic tanks for later usage. Also, when the liquid LH₂, after first being converted to a gaseous form, is sent to a fuel cell for reaction with oxygen as an oxidant across an electrochemical cell to produce electricity, the by-products of which reaction are heat and water that are easily absorbed in the surrounding atmosphere. All of these characteristics support liquid LH₂ as a possible viable green energy source.

Hydrogen can be supplied in both gaseous and liquid form. In liquid form, hydrogen is much colder than other cryogenic liquids, and thus handling liquid hydrogen requires unique design and material considerations. For example, LNG (which is predominantly methane) has a boiling point of −162° C. (−259° F.), while LH₂ is much colder at −253° C. (−423° F.).

This lower boiling point requires that tanks for storage and transportation of LH₂ have more insulation than other liquid forms and since hydrogen is a very small molecule with low viscosity, LH₂ tends to leakage when stored in tanks or transported by pumps. Accordingly, there is a need for improved liquid hydrogen technologies, which include more efficient, less costly liquid hydrogen production processes, improved pumping assemblies and storage systems, and fuel cell engines.

### SUMMARY OF THE INVENTION

The invention relates to a pump assembly specifically designed to handle and transport liquid hydrogen (LH₂) in order to more efficiently overcome the negative drawbacks of LH₂ as a green energy source, such as its lower boiling point (the lowest of all the industrial gases with the exception of helium) and the fact that hydrogen is a very small molecule with low viscosity, and therefore prone to leakage when being transported from large storage tanks to rocket engines on a launching pad or smaller pressurized tanks at refueling stations for semi trailers, buses, fork lifts, delivery trucks, passenger automobiles, and the like. Thus a principal object of the invention is to remedy all the deficiencies encountered in storing LH₂ in insulated storage tanks and withdrawing the LH₂ and transporting it to a smaller tank for use in the final destination, which may be a fuel cell or even an internal combustion engine that utilizes liquid LH₂. Thus, a LH₂ pump assembly, comprising a centrifugal pump, an electric induction motor, and an integrated vacuum jacketed housing comprising an inlet side vacuum jacket and a pump vacuum jacket enclosing the centrifugal pump and a motor vacuum jacket and a discharge side vacuum jacket enclosing the electric induction motor is disclosed herein.

Another object of the invention is to provide a non-submerged pump assembly without any vacuum jacketed housing that uses the process fluid to lubricate and cool the seals and bearings of the pump assembly. The non-submerged pump assembly with or without any vacuum jacketed housing generally may be used in various applications in a horizontal configuration together with an offset discharge tube that provides a vented space at the top of the discharge tube that prevents vapor locks.

Yet another object of the invention is to provide an embodiment wherein the pump assembly is submerged vertically in a cryogenic storage tank filled with LH₂ and the pump assembly is configured with valves at the bottom and at the top of the pump assembly that are configured to take in LH₂ at the bottom of the storage tank and move it to the top of the storage tank for transport to the appropriate LH₂ application, respectively. These submerged-type embodiments may also include embodiments that include submerging the pump assembly in a sump container that is attached to a cryogenic LH₂ storage tank filled with LH₂, where the sump container is positioned either externally and removable or internally and non-removable relative to the LH₂ cryogenic storage tank.

Other devices, systems, methods, features, and advantages of the invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF DRAWINGS

The invention may be better understood by referring to the following figure(s). The components in the figures are not necessarily to scale, emphasis instead being placed upon illustrating the principles of the invention. In the figures, like reference numerals designate corresponding parts throughout the different views.

FIG. 1 illustrates a front perspective view of an exemplary embodiment of an in-line cryogenic LH₂ pump assembly comprising a centrifugal pump, an electric induction motor, and an integrated vacuum jacketed housing, according to the present disclosure.

FIG. 2 illustrates a front perspective view of the cryogenic LH₂ pump assembly of FIG. 1 without the centrifugal pump vacuum jacket and the electric induction motor vacuum jacket in accordance with the present disclosure.

FIG. 3 illustrates a cross-sectional side view of the cryogenic LH₂ pump assembly of FIG. 1, taken along a midline, according to the present disclosure.

FIG. 4 illustrates an exploded view of the cryogenic LH₂ pump assembly of FIG. 2 in accordance with the present disclosure.

FIG. 5 illustrates a front perspective view of an exemplary embodiment of an impeller and diffuser that are configured for implementation in the cryogenic LH2 pump assembly of FIG. 1 in accordance with the present disclosure.

FIG. 6 illustrates a cross-sectional side view of the impeller and diffuser of FIG. 5, taken along a midline, according to the present disclosure.

FIG. 7 illustrates a rear perspective view of the impeller and diffuser of FIG. 5, in accordance with the present disclosure.

FIG. 8 illustrates a front perspective view of another exemplary embodiment of a cryogenic LH₂ pump assembly that includes bayonet connections at an inlet tube and at an outlet tube, in accordance with the present disclosure.

FIG. 9 illustrates a cross-sectional side view of the cryogenic LH₂ pump assembly of FIG. 8, taken along a midline, in accordance with the present disclosure.

FIG. 10 illustrates a cross-sectional side view of the cryogenic LH₂ pump assembly of FIG. 9 coupled with field adapters, according to the present disclosure.

FIG. 11 illustrates a front perspective view of an exemplary embodiment of a cryogenic LH₂ pump assembly without the vacuum jacketed housing, that includes an offset discharge tube, according to the present disclosure.

FIG. 12 illustrates a cross-sectional view of the cryogenic LH₂ pump assembly of FIG. 11, taken along a midline, in accordance with the present disclosure.

FIG. 13 illustrates a front perspective view of an exemplary embodiment of a cryogenic LH₂ pump assembly that includes a strainer coupled with a sump inlet, in accordance with the present disclosure.

FIG. 14 illustrates a front perspective view of the cryogenic LH₂ pump assembly of FIG. 13 together with an offset discharge tube, according to the present disclosure.

FIG. 15 illustrates a front perspective view of an exemplary embodiment of a cryogenic LH₂ pump assembly having an integrated vacuum jacketed housing, together with a bayonet connection and an offset discharge tube, according to the present disclosure.

FIG. 16 illustrates a cross-sectional view of the cryogenic LH₂ pump assembly of FIG. 15 taken along a midline, in accordance with the present disclosure.

FIG. 17A shows a side elevation schematic view of an exemplary embodiment of a cryogenic LH₂ pump assembly according to the present disclosure, vertically submerged in a cryogenic LH₂ storage tank.

FIG. 17B shows a side elevation schematic view of an exemplary embodiment of a cryogenic LH₂ pump assembly according to the present disclosure, vertically submerged in a sump well configured for attachment to a cryogenic LH₂ storage tank.

FIG. 18A shows a side elevation schematic view of an exemplary embodiment of a cryogenic LH₂ pump assembly according to the present disclosure, vertically oriented, and having a vacuum jacket housing and a bayonet connection.

FIG. 18B shows a side elevation schematic view of an exemplary embodiment of a cryogenic LH₂ pump assembly according to the present disclosure, vertically oriented, and having a vacuum jacket housing, a flanged inlet tube, and a flanged outlet tube.

FIG. 18C shows a side elevation schematic view of an exemplary embodiment of a cryogenic LH₂ pump assembly according to the present disclosure, vertically oriented, without a vacuum jacket housing, and having a flanged inlet tube and a flanged outlet tube.

FIG. 18D shows a side elevation schematic view of an exemplary embodiment of a cryogenic LH₂ pump assembly according to the present disclosure, vertically oriented, without a vacuum jacket housing, and having a sump inlet tube and a flanged outlet tube.

FIG. 18E shows a side elevation schematic view of an exemplary embodiment of a cryogenic LH₂ pump assembly according to the present disclosure, vertically oriented, without a vacuum jacket housing, and having a sump inlet tube and an offset flanged outlet tube.

FIG. 18F shows a side elevation schematic view of an exemplary embodiment of a cryogenic LH₂ pump assembly according to the present disclosure, oriented horizontally, with a vacuum jacket housing, and having an offset bayonet connection.

FIG. 18G shows a side elevation schematic view of an exemplary embodiment of a cryogenic LH₂ pump assembly according to the present disclosure, oriented horizontally, without a vacuum jacket housing, and having a flanged inlet tube and an offset flanged discharge tube.

### DETAILED DESCRIPTION OF THE INVENTION

In the following description of the preferred and various alternative embodiments, reference is made to the accompanying drawings that form a part hereof, and which is shown by way of illustration a specific embodiment in which the invention may be practiced. It is to be understood that other embodiments may be utilized, and various structural changes may be made without departing from the spirit and scope of this invention.

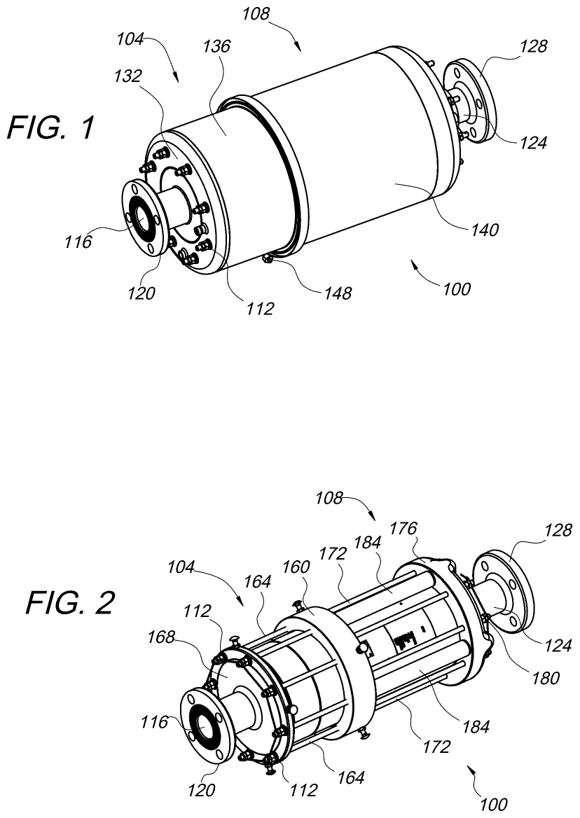

FIG. 1 illustrates an exemplary embodiment of a cryogenic LH₂ pump assembly 100 (hereinafter “pump assembly 100”) that is surrounded by an integrated vacuum jacketed housing, according to the present disclosure. The pump assembly 100 comprises a centrifugal pump 104 that is coupled to an electric induction motor 108 by way of multiple fasteners 112 and pump tie rods 164 (see FIG. 2). The centrifugal pump 104 includes an inlet tube 116 configured to allow the centrifugal pump 104 to intake LH₂. In the illustrated embodiment of FIG. 1, the inlet tube 116 includes an inlet flange 120 configured to enable coupling the inlet tube 116 with a source of LH₂. The electric induction motor 108 includes a discharge tube 124 configured to allow the LH₂ to exit the centrifugal pump 104. In the embodiment shown in FIG. 1, the discharge tube 124 includes a discharge flange 128 configured to enable coupling the discharge tube 124 with downstream equipment, without limitation.

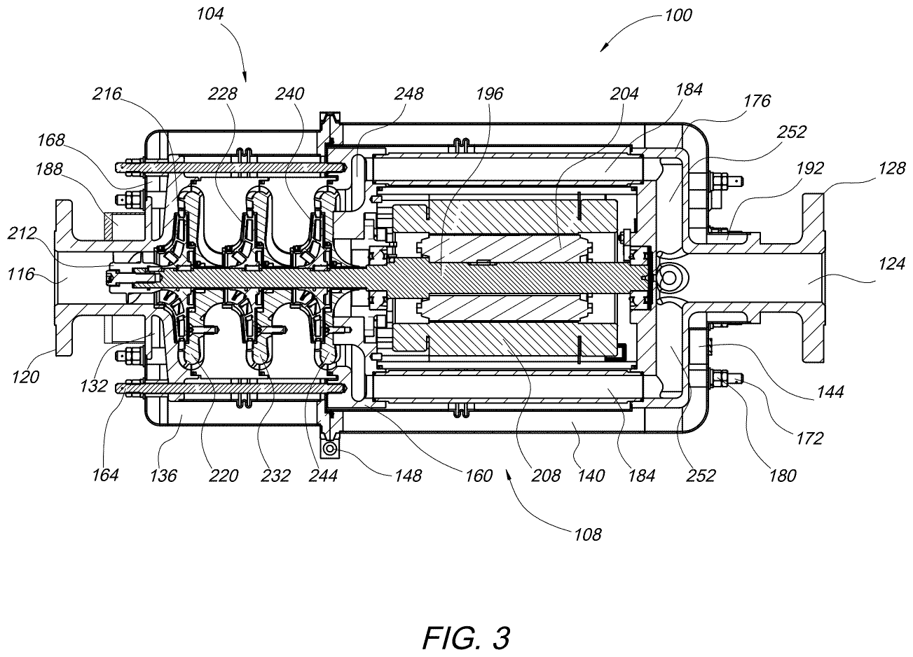

As mentioned above, the pump assembly 100 is surrounded by a vacuum jacketed housing. More specifically, the centrifugal pump 104 is disposed within an inlet side vacuum jacket 132 and a pump vacuum jacket 136. The electric induction motor 108 is disposed within a motor vacuum jacket 140 and a discharge side vacuum jacket 144 (see FIG. 3). As shown in FIG. 1, the pump and motor vacuum jackets 136, 140 are joined by a vacuum jacket connector 148. The vacuum jacketed housing is configured to minimize heat loss around the centrifugal pump 104 arising due to the very low temperature of LH₂. It is contemplated that the vacuum jacketed housing further obviates disposing the pump assembly 100 within a sump or column for cooling the centrifugal pump 104. Because the pump assembly 100 is surrounded by the vacuum jacketed housing, there is no way to monitor the cooling of the centrifugal pump 104. Thus, it is contemplated that an integral temperature monitoring device can be embedded into the motor windings comprising the electric induction motor 108.

FIG. 2 illustrates the pump assembly 100 without the vacuum jacketed housing, according to the present disclosure. This pump assembly 100 may be vertically installed in an insulated cryogenic tank containing LH₂ as a submerged cryogenic LH₂ pump assembly and may also be configured to operate without being submerged in a storage tank by providing internal passages in the pump assembly 100 to provide lubrication to the bearings of the pump assembly 100 with the process fluid. As shown in FIG. 2, the inlet tube 116 is coupled to an inlet manifold 168 in fluid communication with an intake side of the centrifugal pump 104, configured to provide the centrifugal pump 104 with LH₂. The centrifugal pump 104 is fastened to an intervening coupling manifold 160 by way of a multiplicity of pump tie rods 164 that are threaded into holes (not shown) disposed within an inlet side of the coupling manifold 160. The fasteners 112 also couple an inlet manifold 168 to the intake of the centrifugal pump 104 by way of the pump tie rods 164. In an embodiment, the fasteners 112 comprise hex nuts and/or hex jam nuts which are attached to the threaded fastener end of a pump tie rod 164 passed through a hole (not shown) disposed within the inlet manifold 168 that are configured, when tightened, to prevent loosening of the pump tie rods 164.

The electric induction motor 108 is attached to the coupling manifold 160 by way of a multiplicity of motor tie rods 172 that are fastened between the coupling manifold 160 and a discharge manifold 176 comprising the pump assembly 100. In the illustrated embodiment of FIG. 2, one coupling end of each motor tie rod 172 is threaded into holes (not shown) disposed within an outlet side of the coupling manifold 160 while an opposite fastener end of the motor tie rod 172 is attached to the discharge manifold 176 by way of fasteners 180. In an embodiment, the fasteners 180 comprise hex nuts and/or hex jam nuts which are attached to the threaded fastener end of a motor tie rod 172 passed through a hole (not shown) disposed within the discharge manifold 176 that are configured, when tightened, to prevent loosening of the motor tie rods 172.

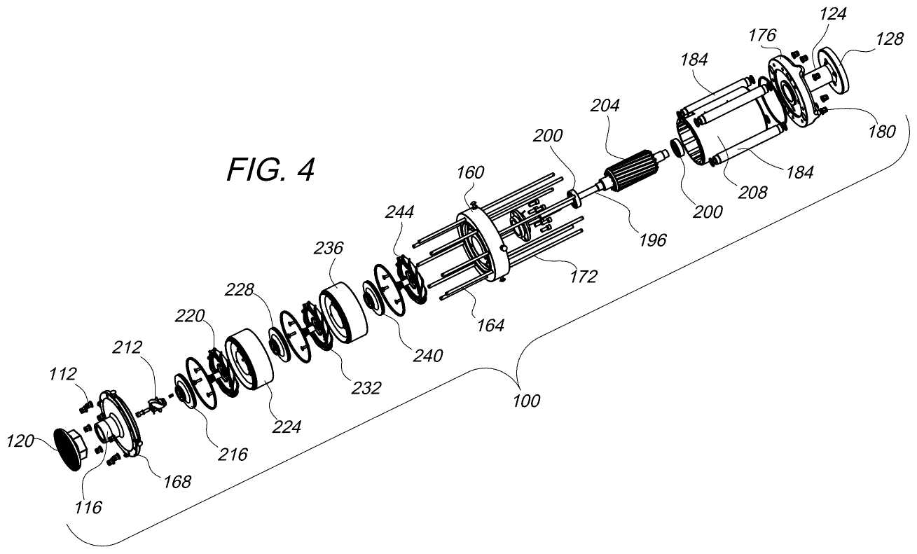

Turning to FIG. 4, this embodiment shows eight fasteners 112 positioned in the inlet manifold 168 and eight fasteners 180 positioned near the discharge manifold 176. Accordingly, in the embodiment, there will be eight pump tie rods 164 and eight motor tie rods 172. In other embodiments, there may be any number of pump tie rods and motor tie rods dependent on the size of the pump and motor and other factors.

As shown in FIG. 2, multiple longitudinal discharge tubes 184 are disposed between the coupling manifold 160 and the discharge manifold 176. As described herein, the coupling manifold 160 is configured to direct LH₂ received from the centrifugal pump 104 into the longitudinal discharge tubes 184. The LH₂ is pumped through the longitudinal discharge tubes 184 to the discharge manifold 176. The discharge manifold 176 combines the LH2 flows received from the multiple longitudinal discharge tubes 184 into a single LH₂ flow which then exits the pump assembly 100 by way of the discharge tube 124. In the illustrated embodiment of FIG. 2, there are four longitudinal discharge tubes 184 uniformly disposed at 90-degree intervals around the circumference of the pump assembly 100. It is contemplated, however, that, in some embodiments, any number of longitudinal discharge tubes 184 may be disposed at any of various intervals around the circumference of the pump assembly 100, without limitation.

FIG. 3 illustrates a cross-sectional side view of the pump assembly 100 shown in FIG. 1, taken along a midline, according to the present disclosure. As shown in FIG. 3, the pump assembly 100 is surrounded by a vacuum jacketed housing configured to minimize heat loss from the pump assembly 100 to surrounding environment in which the pump assembly 100 may be exposed. The vacuum jacketed housing comprises the inlet side vacuum jacket 132, the pump vacuum jacket 136, the motor vacuum jacket 140, and the discharge side vacuum jacket 144. Further, an inlet tube vacuum jacket 188 surrounds the inlet tube 116, while a discharge tube vacuum jacket 192 surrounds the discharge tube 124. As such, the inlet tube 116 and the surrounding inlet tube vacuum jacket 188 provide a coaxial inlet connection to the pump assembly 100, while the discharge tube 124 and the surrounding discharge tube vacuum jacket 192 provide a coaxial discharge connection to the pump assembly 100. It is contemplated that the coaxial inlet and discharge connections will minimize the ancillary equipment needed and allow for easier installation of the pump 100. Further, in some embodiments, the pump assembly 100 may include bayonet connections, as described herein below.

As shown in FIGS. 3-4, the pump assembly 100 comprises a single motor/pump shaft 196 that extends from the electric induction motor 108 through the centrifugal pump 104. As best shown in FIG. 4, the motor/pump shaft 196 is supported by bearings 200 (one positioned on each end of a motor commutator 204) and thus is configured to rotate within the pump assembly 100. The motor commutator 204 is mounted on the motor/pump shaft 196 and configured to be turned by a motor stator 208 that is disposed within the electric induction motor 108. Further, as shown in FIG. 4, the motor stator 208 is surrounded by the longitudinal discharge tubes 184. The electric induction motor 108 is cooled by internal passages disposed in the electric induction motor 108 between the coupling manifold and the discharge manifold. In some embodiments, the temperature of the electric induction motor 108 may be monitored by an integral temperature sensing device that is embedded in the motor stator 208.

As best shown in FIGS. 3-4, the motor/pump shaft 196 extends through the centrifugal pump 104 to the inlet manifold 168. An inducer 212 is mounted to the end of the motor/pump shaft 196 within the inlet tube 116. Following the inducer 212 is a first impeller 216 that is coupled with the motor/pump shaft 196. The first impeller 216 rotates with respect to a first diffuser 220 that is fixedly coupled with a first diffuser housing 224. The first impeller 216 and the first diffuser 220 are adapted to efficiently move LH₂ from the inlet tube 116 to a second impeller 228 that rotates with respect to a second diffuser 232. The second diffuser 232 is fixedly coupled with a second diffuser housing 236. The second impeller 228 and the second diffuser 232 are configured to efficiently move LH2 beyond the second diffuser housing 236 to a third impeller 240. The third impeller 240 rotates with respect to a third diffuser 244 that is fixedly coupled with a front side of a coupling manifold 160 (see FIG. 4). As such, the third impeller 240 and the third diffuser 244 are adapted to efficiently move LH₂ into the coupling manifold 160.

With continuing reference to FIG. 3, LH₂ exiting the centrifugal pump 104 is pumped to the coupling manifold 160. More specifically, the coupling manifold 160 includes an annulus 248 that is configured to pass LH₂ received from the third impeller and diffuser 240, 244 to the longitudinal discharge tubes 184. In the illustrated embodiment of FIG. 4, there are four longitudinal discharge tubes 184 uniformly disposed at 90-degree intervals around the circumference of the motor stator 208. Given that the annulus 248 establishes fluid communication between the third impeller and diffuser 240, 244 and each longitudinal discharge tube 184 it should be recognized that, in the illustrated embodiment, the annulus 248 is configured to combine all of the process fluid from the third diffuser 244 into a single flow for transfer to the longitudinal discharge tubes 184 of the electric induction motor. It is contemplated, however, that, in some embodiments, the annulus 248 may be disposed in any arrangement within the coupling manifold 160 that establishes fluid communication between the third impeller and diffuser 240, 244 and the longitudinal discharge tubes 184, which may vary in number, without limitation.

Moreover, as shown in FIG. 3, the discharge manifold 176 includes transverse discharge channels 252 that are configured to pass LH₂ received from the longitudinal discharge tubes 184 to the discharge tube 124. Each transverse discharge channel 252 extends radially inward within the discharge manifold 176 to the discharge tube 124. Given that there are four longitudinal discharge tubes 184 uniformly disposed at 90-degree intervals around the circumference of the motor stator 208, as described herein, it should be understood that, in the illustrated embodiment of FIGS. 3-4, there are four transverse discharge channels 252 disposed at 90-degree intervals around the circumference of the discharge manifold 176 and in fluid communication with the discharge tube 124. In some embodiments, any number of transverse discharge channels 252 may be disposed in any arrangement within the discharge manifold 176 that establishes fluid communication between the longitudinal discharge tubes 184 and the discharge tube 124, without limitation.

Continuing with FIG. 3, the centrifugal pump 104 of the pump assembly 100 is a multi-stage centrifugal pump with three stages, wherein the flow rate and head of the LH₂ increases as it passes through each stage. Each stage consists of an impeller-diffuser pair, specifically, the first stage impeller-diffuser pair 216, 220, the second stage impeller-diffuser pair 228, 232, and the third stage impeller-diffuser pair 240, 244. The disadvantages of multi-stage centrifugal pumps are higher initial cost, more complex installation because of the multiple stages, increased energy consumption because of higher pressure operations, and increased weight of the centrifugal pump 100. Accordingly, for some applications a single-stage centrifugal pump may be selected. On the other hand, multi-stage centrifugal pumps provide a flexible range of flow and head and a high degree of energy efficiency, thus any number of multiple stages can be used from two stages, three stages, four stages, or any number of stages.

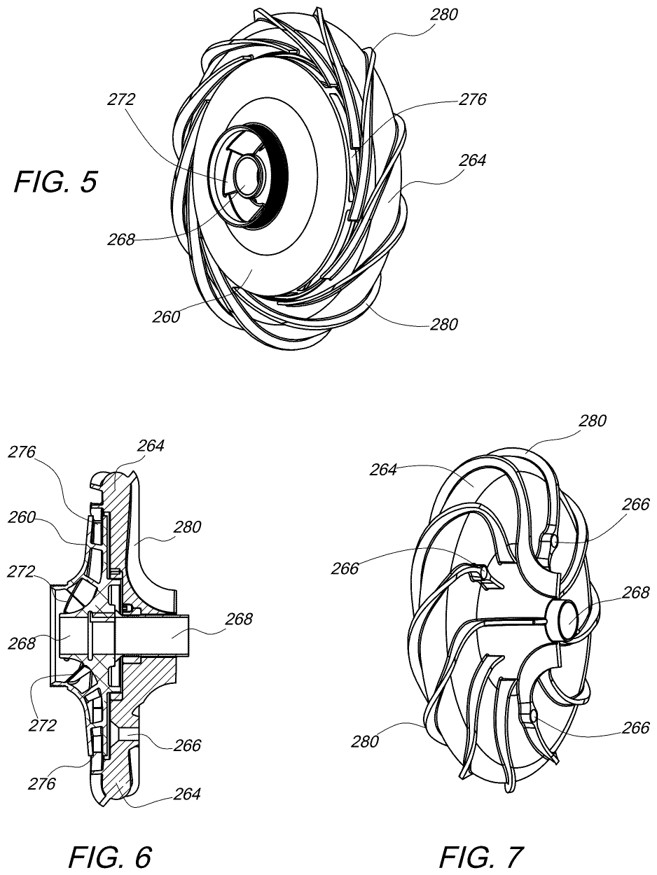

Turning, now, to FIGS. 5-7, an impeller 260 and a diffuser 264 are shown. The impeller 260 and diffuser 264 are configured to be implemented in the centrifugal pump 104, described with respect to FIGS. 1-4. It should be understood, therefore, that the impeller 260 and the diffuser 264 are substantially identical to each of the first, second, and third impeller/diffuser pairs discussed hereinabove.

In general, the impeller 260 is configured to rotate while the diffuser 264 remains fixed to a diffuser housing comprising the centrifugal pump 104, such as, for example, the first diffuser housing 224 shown in FIG. 4. The diffuser 264 includes holes 266 (see FIGS. 6 and 7) configured to receive fasteners that fixedly couple the diffuser 264 to the diffuser housing 224. The impeller 260 includes a central hole 268 that receives the motor/pump shaft 196 (see FIG. 4) for rotating the impeller 260. The impeller 260 includes blades 272 that are configured to intake LH₂ at a central region of the impeller 260 and propel the LH₂ radially to peripheral openings 276 disposed around the circumference of the impeller 260. It is contemplated that the blades 272 and the peripheral openings 276 are configured to advantageously operate with the unique properties of LH_{2.}

As will be appreciated, LH₂ exiting the peripheral openings 276 of the impeller 260 is directed into spaces between the diffuser 264, blades 280 arranged on the diffuser 264, and the diffuser housing 224 to which the diffuser 264 is fastened. The blades 280 are arranged on the diffuser 264 such that the LH₂ encounters an increasing cross-sectional area as the LH₂ moves around the diffuser 264. It is contemplated that the blades 280 are configured to operate advantageously with the unique properties of LH_{2.}

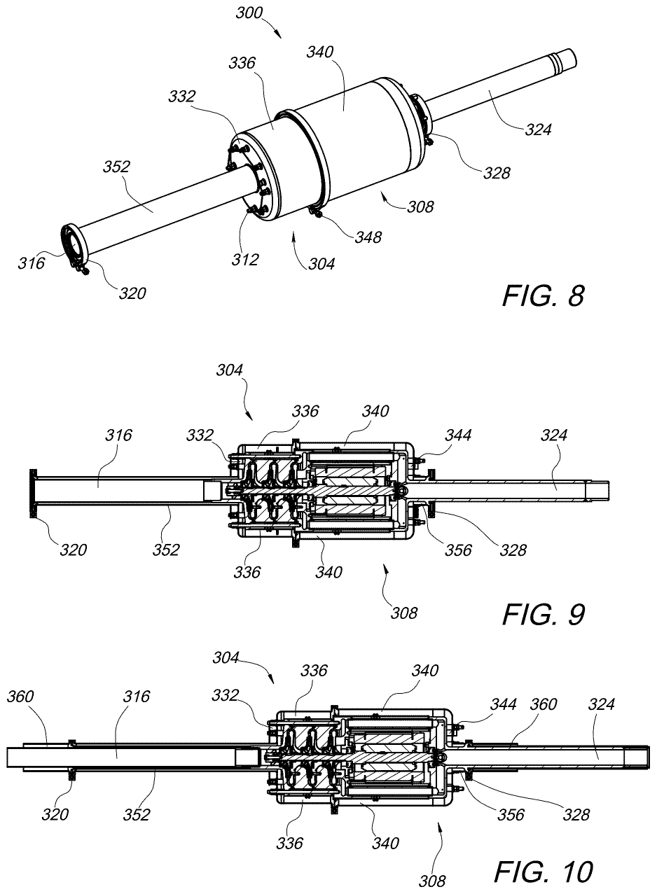

FIG. 8 illustrates an exemplary embodiment of a LH₂ pump assembly 300 (hereinafter “pump assembly 300”) that is surrounded by a vacuum jacketed housing, according to the present disclosure. The pump assembly 300 shown in FIG. 8 is substantially similar to the pump assembly 100, shown in FIG. 1, with the exception that pump assembly 300 includes bayonet connections, as described herein.

The pump assembly 300 comprises a centrifugal pump 304 that is coupled to an electric induction motor 308 by way of multiple fasteners 312. The centrifugal pump 304 includes an inlet tube 316 configured to allow the pump assembly 300 to intake LH₂. In the illustrated embodiment of FIG. 8, the inlet tube 316 includes a bayonet connection 320 configured to enable coupling the inlet tube 316 with a source of LH₂. The electric induction motor 308 includes a discharge tube 324 configured to allow the LH₂ to exit the pump assembly 300. In the embodiment shown in FIG. 8, the discharge tube 324 includes a bayonet connection 328 configured to enable coupling the discharge tube 324 with downstream equipment, without limitation.

As mentioned above, the pump assembly 300 is surrounded by a vacuum jacketed housing. More specifically, the centrifugal pump 304 is disposed within an inlet side vacuum jacket 332 and a pump vacuum jacket 336. The electric induction motor 308 is disposed within a motor vacuum jacket 340 and a discharge side vacuum jacket 344 (see FIG. 9). As shown in FIG. 8, the pump and motor vacuum jackets 336, 340 are joined by a vacuum jacket connector 348. Further, an inlet tube vacuum jacket 352 surrounds the inlet tube 316, while a discharge tube vacuum jacket 356 (see FIG. 9) surrounds the discharge tube 324. As such, the inlet tube 316 and the surrounding inlet tube vacuum jacket 352 provide a coaxial inlet connection to the pump assembly 300, while the discharge tube 324 and the surrounding discharge tube vacuum jacket 356 provide a coaxial discharge connection to the pump assembly 300. Further, as shown in FIG. 10, a field adapter 360 can be coupled with each of the bayonet connections 328, 320. It is contemplated that the coaxial inlet and discharge connections, and the field adapters 360, will minimize required ancillary equipment and allow for an easier installation of the pump assembly 300.

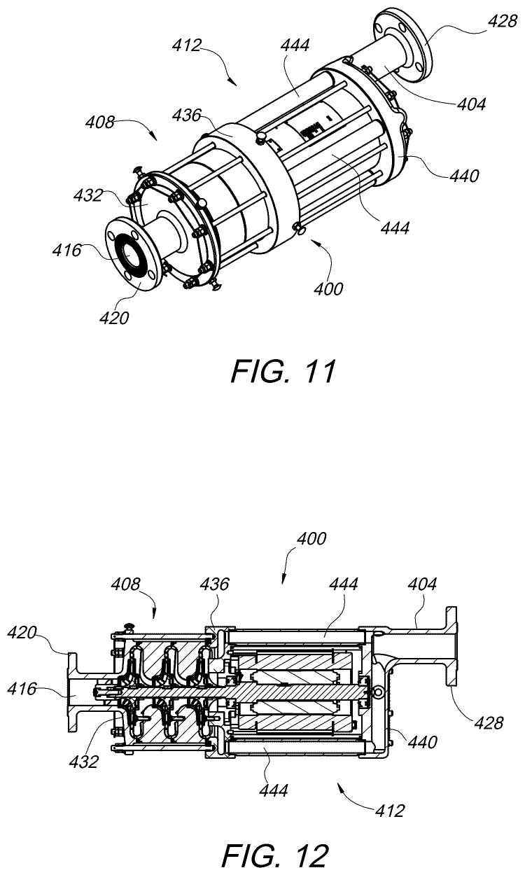

FIG. 11 illustrates an exemplary embodiment of a pump assembly 400 without a vacuum jacketed housing, according to the present disclosure. The pump assembly 400 is substantially similar to the pump assembly 100, shown in FIG. 2, with the exception that the pump assembly 400 includes an offset discharge tube 404 to prevent vapor lock. Similar to the pump assembly 100, the pump assembly 400 comprises a centrifugal pump 408 that is fastened to an electric induction motor 412. The pump 408 includes an inlet tube 416 configured to allow the pump assembly 400 to intake LH₂. In the illustrated embodiment of FIG. 11, the inlet tube 416 includes an inlet flange 420 configured to enable coupling the inlet tube 416 with a source of LH₂. The electric induction motor 412 includes the offset discharge tube 404 configured to allow the LH₂ to exit the pump assembly 400. In the embodiment shown in FIG. 11, the discharge tube 404 includes a discharge flange 428 configured to enable coupling the offset discharge tube 404 with downstream equipment, without limitation.

As shown in FIGS. 11-12, the pump assembly 400 comprises an inlet manifold 432, a coupling manifold 436, and a discharge manifold 440. Multiple longitudinal discharge tubes 444 are disposed between the coupling manifold 436 and the discharge manifold 440. As described herein, the coupling manifold 436 directs LH₂ received from the pump 408 into the longitudinal discharge tubes 444. The LH₂ is pumped through the longitudinal discharge tubes 444 to the discharge manifold 440. The discharge manifold 440 combines the LH₂ flows received from the multiple longitudinal discharge tubes 444 into a single LH₂ flow which then exits the pump assembly 400 by way of the offset discharge tube 404. In the illustrated embodiment of FIGS. 11-12, there are four longitudinal discharge tubes 444 uniformly disposed at 90-degree intervals around the circumference of the pump assembly 400. It is contemplated, however, that, in some embodiments, any number of longitudinal discharge tubes 444 may be disposed at any of various arrangements around the circumference of the pump assembly 400, without limitation.

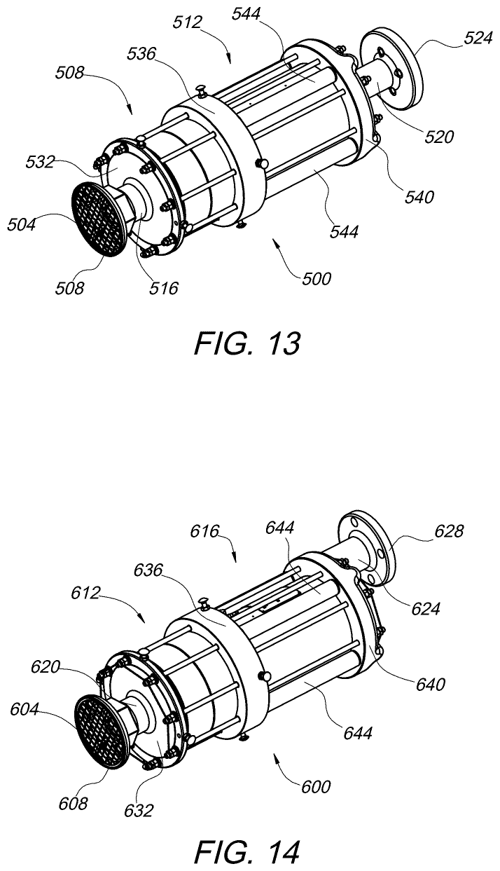

FIG. 13 illustrates an exemplary embodiment of a pump assembly 500 without a vacuum jacketed housing, according to the present disclosure. The pump assembly 500 is substantially similar to the pump assembly 100, shown in FIG. 2, with the exception that the pump assembly 500 includes a strainer 504 coupled with a sump inlet 508. Similar to the pump assembly 100, the pump assembly 500 comprises a centrifugal pump 508 that is fastened to an electric induction motor 512. The centrifugal pump 508 includes an inlet tube 516 configured to allow the pump assembly 500 to intake LH₂. In the illustrated embodiment of FIG. 13, the inlet tube 516 includes the sump inlet 508 configured to enable submerging the pump assembly 500 in a relatively large tank of LH₂. The motor 512 includes a discharge tube 520 configured to allow the LH₂ to exit the pump assembly 500. In the embodiment shown in FIG. 13, the discharge tube 520 includes a discharge flange 524 configured to enable coupling the discharge tube 520 with downstream equipment, without limitation.

With continuing reference to FIG. 13, the pump assembly 500 includes an inlet manifold 532, a coupling manifold 536, and a discharge manifold 540. Multiple longitudinal discharge tubes 544 are disposed between the coupling manifold 536 and the discharge manifold 540. As described herein, the coupling manifold 536 directs LH₂ received from the pump assembly 508 into the longitudinal discharge tubes 544. The LH₂ is pumped through the longitudinal discharge tubes 544 to the discharge manifold 540. The discharge manifold 540 combines the LH₂ flows received from the longitudinal discharge tubes 544 into a single LH₂ flow which then exits the pump assembly 500 by way of the discharge tube 520. In the illustrated embodiment of FIG. 13, there are four longitudinal discharge tubes 544 uniformly disposed at 90-degree intervals around the circumference of the pump assembly 500. It is contemplated, however, that, in some embodiments, any number of longitudinal discharge tubes 544 may be disposed at any of various arrangements around the circumference of the pump assembly 500, without limitation.

FIG. 14 illustrates an exemplary embodiment of a pump assembly 600 without a vacuum jacketed housing, according to the present disclosure. The pump assembly 600 is substantially similar to the pump assembly 400, shown in FIGS. 11-12, with the exception that the pump assembly 600 includes a strainer 604 coupled with a sump inlet 608. Similar to the pump assembly 400, the pump assembly 600 comprises a pump 612 that is fastened to an electric induction motor 616. The centrifugal pump 612 includes an inlet tube 620 configured to allow the pump assembly 600 to intake LH₂ by way of the inlet manifold 632. In the illustrated embodiment of FIG. 14, the inlet tube 620 includes the sump inlet 608 to enable the pump assembly 600 to be submerged in a relatively large cryogenic storage tank of LH₂. The electric induction motor 616 includes an offset discharge tube 624 configured to allow the LH₂ to exit the pump 600. In the embodiment shown in FIG. 14, the offset discharge tube 624 includes a discharge flange 628 configured to enable coupling the offset discharge tube 624 with downstream equipment, without limitation.

As shown in FIG. 14, the pump assembly 600 comprises an inlet manifold 632, a coupling manifold 636, and a discharge manifold 640. Multiple longitudinal discharge tubes 644 are disposed between the coupling manifold 636 and the discharge manifold 640. As described herein, the coupling manifold 636 directs LH₂ received from the centrifugal pump 612 into the longitudinal discharge tubes 644. The LH₂ is pumped through the longitudinal discharge tubes 644 to the discharge manifold 640. The discharge manifold 640 combines the LH₂ flows received from the longitudinal discharge tubes 644 into a single LH₂ flow which then exits the pump assembly 600 by way of the offset discharge tube 624. As shown in FIG. 14, there are four longitudinal discharge tubes 644 uniformly disposed at 90-degree intervals around the circumference of the pump assembly 600. As stated hereinabove, however, in some embodiments, any number of longitudinal discharge tubes 644 may be disposed at any of various arrangements around the circumference of the pump assembly 600, without limitation.

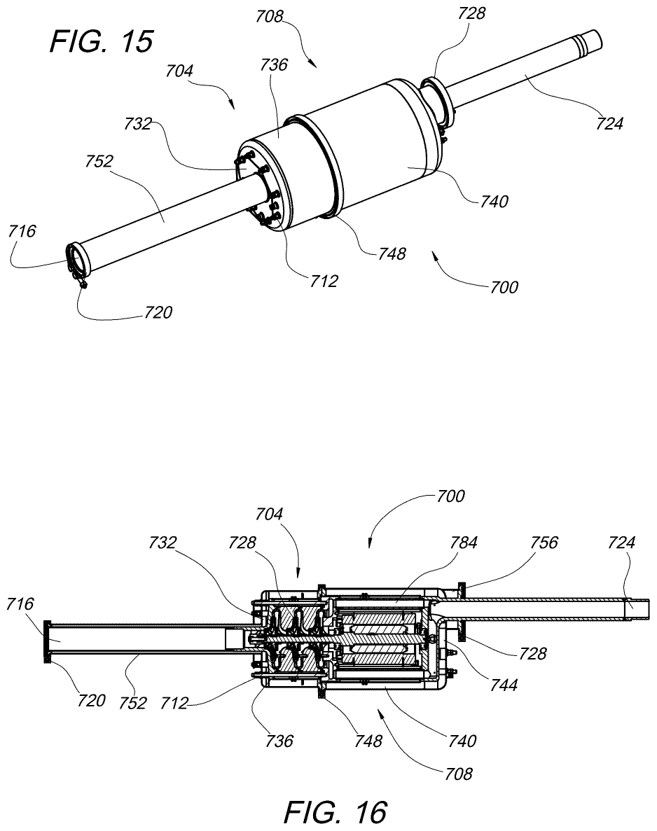

FIG. 15 illustrates an exemplary embodiment of a pump assembly 700 with an integrated vacuum jacketed housing, according to the present disclosure. The pump assembly 700 is substantially similar to the pump assembly 300, shown in FIG. 8, with the exception that the pump assembly 700 includes an offset discharge tube 724. Similar to the pump assembly 100, the pump assembly 700 comprises a centrifugal pump 704 that is fastened to an electric induction motor 708. The pump 704 includes an inlet tube 716 configured to allow the pump assembly 700 to intake LH₂. In the illustrated embodiment of FIG. 15 the inlet tube 716 includes a bayonet connection 720 configured to facilitate coupling the inlet tube 716 with a source of LH₂. The electric induction motor 708 includes the offset discharge tube 724 configured to allow the LH₂ to exit the pump assembly 700. FIG. 16 illustrates a cross-sectional view of the cryogenic LH₂ pump assembly of FIG. 15, taken along a midline, and discloses that the offset discharge tube 724 provides a vertical offset, which facilitates operating the pump assembly 700 in a horizontal configuration.

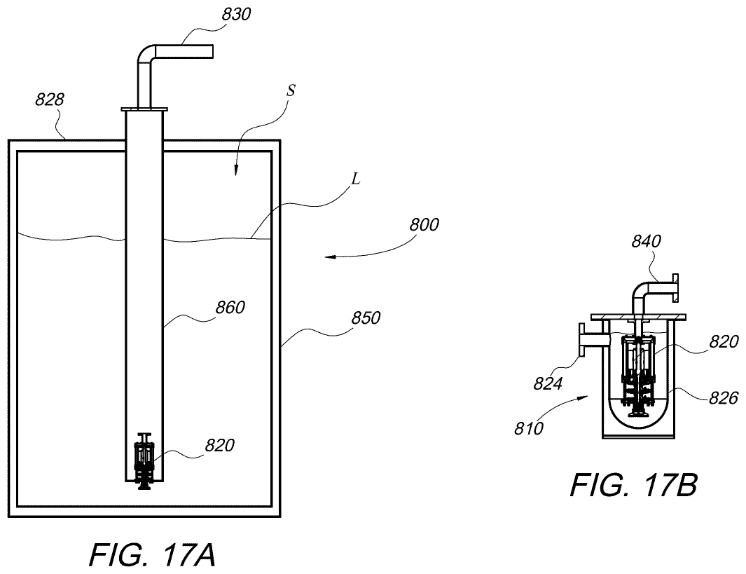

FIG. 17A shows a side elevation schematic view of an exemplary embodiment of a cryogenic LH₂ pump assembly 820 according to the present disclosure, submerged vertically in an insulated cryogenic LH₂ storage tank 800. The LH₂ storage tank 800 contains LH₂ up to the liquid level L, and the space S between the liquid level L and the roof 828 of the LH₂ storage tank 800 is filled with gas boiling off from the liquid LH₂. The LH₂ storage tank 800 includes insulated walls 850, a discharge tube 830, and a casing 860.

FIG. 17B shows a side elevation schematic view of an exemplary embodiment of a cryogenic LH₂ pump assembly according to the present disclosure, submerged vertically in a sump well 826 of a sump 810, which includes an inlet tube 824 and an outlet tube 840.

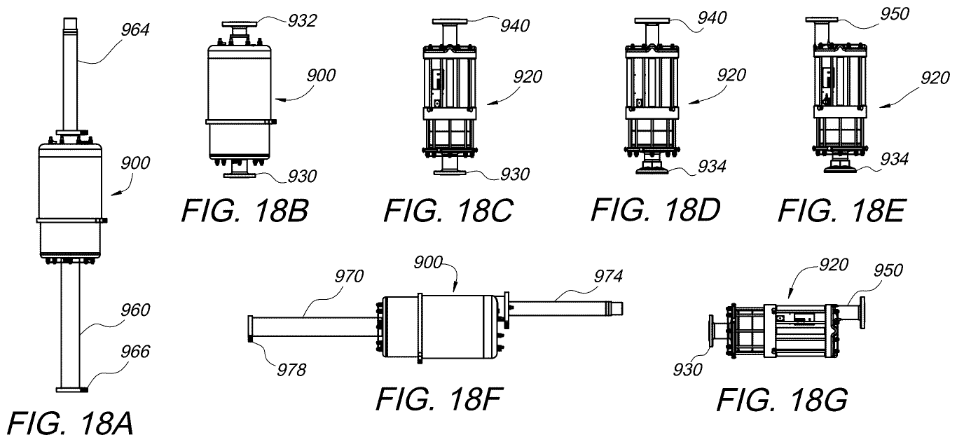

FIG. 18A shows a side elevation schematic view of an exemplary embodiment of a cryogenic LH₂ pump assembly 900 comprising a vacuum jacket housing, according to the present disclosure, in a vertical configuration, and that includes an inlet tube 960, an outlet tube 964, and a bayonet connection 966.

FIG. 18B shows a side elevation schematic view of another exemplary embodiment of a cryogenic LH₂ pump assembly 900 comprising a vacuum jacket housing, according to the present disclosure, in a vertical configuration, and that includes an inlet tube with flange 930 and an outlet tube with flange 932.

FIG. 18C shows a side elevation schematic view of another exemplary embodiment of a cryogenic LH₂ pump assembly 920 without a vacuum jacket housing, according to the present disclosure, in a vertical configuration, and that includes an inlet tube with flange 930 and an outlet tube with flange 940.

FIG. 18D shows a side elevation schematic view of another exemplary embodiment of a cryogenic LH₂ pump assembly 920 without vacuum jacket housing, according to the present disclosure, in a vertical configuration, and that includes a sump inlet 934 and an outlet tube with flange 940.

FIG. 18E shows a side elevation schematic view of another exemplary embodiment of a cryogenic LH₂ pump assembly 920 without a vacuum jacket housing, according to the present disclosure, in a vertical configuration, and that includes a sump inlet 934 and an offset outlet tube with flange 950.

FIG. 18F shows a side elevation schematic view of an exemplary embodiment of a cryogenic LH₂ pump assembly 900 comprising a vacuum jacket housing, according to the present disclosure, in a horizontal configuration, and that includes an inlet tube 970, an offset outlet tube 974, and a bayonet connection 978.

FIG. 18G shows a side elevation schematic view of another exemplary embodiment of a cryogenic LH₂ pump assembly 920 without vacuum jacket housing, according to the present disclosure, in a horizontal configuration, and that includes an inlet tube with a flange 930 and an offset outlet tube with flange 950.

What is claimed is:

1. An in-line coaxial liquid hydrogen cryogenic (LH₂) pump assembly, comprising:
a centrifugal pump having an inlet side and an outlet side;
an electric induction motor having an inflow side and an outflow side, coupled with the centrifugal pump;
a vacuum jacketed housing comprising:
an inlet side vacuum jacket and a pump vacuum jacket enclosing the centrifugal pump;
a motor vacuum jacket and a discharge side vacuum jacket enclosing the electric induction motor; and
a vacuum jacket connector connecting the centrifugal pump vacuum jacket and the electric induction motor vacuum jacket;
an inlet tube coupled with the inlet side of the centrifugal pump; and
a discharge tube coupled with the outflow side of the electric induction motor.

2. The in-line coaxial cryogenic LH₂ pump assembly of claim 1, further comprising:
an inlet flange affixed to a front end of the inlet tube configured to enable the inlet tube to connect with a source of LH₂; and
a discharge flange affixed to a back end of the discharge tube configured to enable coupling the discharge tube with downstream ancillary equipment.

3. The in-line coaxial cryogenic LH₂ pump assembly of claim 2, further comprising:
an inlet manifold in fluid communication with the inlet side of the centrifugal pump, configured to provide the centrifugal pump with LH₂ from a source of LH₂ by way of the inlet manifold; and
a coupling manifold having an inlet side and an outlet side, wherein the inlet side of the coupling manifold is configured to pass LH₂ from the outlet side of the centrifugal pump through multiple longitudinal discharge tubes to an inflow side of a discharge manifold, wherein the inflow side of the discharge manifold is coupled to an outflow side of the longitudinal discharge tubes and an outflow side of the discharge manifold is coupled to the discharge tube.

4. The in-line coaxial cryogenic LH₂ pump assembly of claim 3, wherein the centrifugal pump and the electric induction motor are attached to each other by way of a multiplicity of pump tie rods arranged symmetrically around the inlet manifold and the coupling manifold, with each pump tie rod having a coupling end having an external thread enabling threading the coupling end into one of a multiplicity of equally-disposed holes around the perimeter of the coupling manifold on its inlet side, and a fastener end with an external thread configured to receive and retain a fastener such as a hex nut and/or a hex jam nut, which is affixed to the fastener end after it is passed through a corresponding hole of a multiplicity of equally-disposed holes around the perimeter of the inlet manifold;
and wherein the electric induction motor and the discharge manifold are attached to each other by way of a multiplicity of motor tie rods arranged symmetrically around the coupling manifold and the discharge manifold, with each motor tie rod having a coupling end having an external thread enabling threading the coupling end into one of a multiplicity of equally-disposed holes around the perimeter of the coupling manifold on its outlet side, and a fastener end with an external thread configured to receive and retain a fastener such as a hex nut and/or a hex jam nut, which is affixed to the fastener end after it is passed through a corresponding hole of a multiplicity of equally-disposed holes around the perimeter of the discharge manifold.

5. The in-line coaxial cryogenic LH₂ pump assembly of claim 1, wherein the centrifugal pump comprises:
a single motor/pump shaft that extends from the electric induction motor through the centrifugal pump to the inlet tube and is supported by a pair of bearings disposed in the electric induction motor thus supporting the centrifugal pump and the electric induction motor to rotate within the LH₂ pump assembly.

6. The in-line coaxial cryogenic LH₂ pump assembly of claim 1, wherein the electric induction motor comprises a commutator mounted on the motor/pump shaft configured to be rotated by a motor stator disposed within the electric induction motor.

7. The in-line coaxial LH₂ pump assembly of claim 1, comprising:
an inlet bayonet connection attached to an outer end of the inlet tube configured to enable the inlet tube to connect with a source of LH₂; and
an outlet bayonet connection attached to an outer end of the discharge tube configured to enable the discharge tube to connect with downstream ancillary equipment.

8. The in-line coaxial cryogenic LH₂ pump assembly of claim 5, wherein the centrifugal pump further comprises:
an inducer mounted at the end of the motor/pump shaft within the inlet tube;
a plurality of stage units wherein each stage unit comprises an impeller coupled to the motor/pump shaft that rotates with respect to a diffuser fixedly coupled with a diffuser housing that encloses both the impeller and diffuser, excepting the last stage unit which is coupled directly to a coupling manifold, whereby LH₂ flows sequentially through each stage unit thereby decreasing velocity and increasing head through each stage unit and is efficiently moved to the coupling manifold coupled to the discharge tube.

9. The in-line coaxial cryogenic LH₂ pump assembly of claim 8, wherein each diffuser of the centrifugal pump comprises blades affixed on the diffuser such that LH₂ flowing through the stage unit encounters an increasing cross-sectional area as it moves through and around the corresponding diffuser thus increasing the head of the LH₂.

10. The in-line coaxial cryogenic LH₂ pump assembly of claim 7, wherein a first field adapter is coupled with the inlet bayonet connection and a second field adapter is coupled with the outlet bayonet connection.

11. The in-line coaxial cryogenic LH₂ pump assembly of claim 6, wherein the motor stator is surrounded by a plurality of longitudinal discharge tubes uniformly disposed around the circumference of the motor stator, which longitudinal discharge tubes are in fluid communication with a discharge manifold coupled with discharge tube.

12. An in-line coaxial liquid hydrogen (LH₂) pump assembly, comprising:
a centrifugal pump;
an electric induction motor coupled with the centrifugal pump;
an inlet tube coupled with the centrifugal pump; and
a discharge tube coupled with the electric induction motor.

13. The in-line coaxial cryogenic LH₂ pump assembly of claim 12, wherein an annulus disposed in a coupling manifold is configured to combine all of the LH₂ from a final diffuser of the centrifugal pump for transfer to multiple longitudinal discharge tubes uniformly disposed at intervals around the circumference of a motor stator of the electric induction motor, and wherein an integrated temperature sensing device is embedded in the motor stator of the electric induction motor for monitoring temperature.

14. The in-line coaxial LH₂ pump assembly of claim 12, wherein the electric induction motor and bearings are cooled by internal passages disposed in the electric induction motor between the coupling manifold and the discharge manifold.

15. The in-line coaxial LH₂ pump assembly of claim 12, configured to operate horizontally in a stationary or vehicle mounted configuration, wherein the discharge tube is configured as an offset discharge tube to prevent vapor lock.

16. A submersible liquid hydrogen cryogenic (LH₂) pump assembly, particularly adapted for pumping LH₂ from insulated cryogenic storage tanks containing LH₂, wherein the submersible cryogenic LH₂ pump assembly is configured to be vertically submerged in an LH₂ cryogenic storage tank, the submersible LH₂ pump assembly comprising:
a centrifugal pump comprising an inlet tube, together with a sump inlet configured to enable the LH₂ pump assembly to intake LH₂ from the LH₂ cryogenic storage tank; and
an electric induction motor coupled with the centrifugal pump, the electric induction motor comprising a discharge manifold, together with a discharge tube.

17. The submersible cryogenic LH₂ pump assembly of claim 16, wherein the submersible cryogenic LH₂ pump assembly is submerged vertically in a sump container.

18. The submersible cryogenic LH₂ pump assembly of claim 17, wherein the sump container is positioned externally and removable relative to the LH₂ cryogenic storage tank.

19. The submersible cryogenic LH₂ pump assembly of claim 17, wherein the sump container is positioned internally and non-removable relative to the LH₂ cryogenic storage tank.

20. The submersible cryogenic LH₂ pump assembly of claim 16, further comprising a strainer coupled with an inlet tube coupled with the intake side of the centrifugal pump.
